(19) United States
(12) Patent Application Publication
(10) Pub. No.: US 2005/0048169 A1
(43) Pub. Date: Mar. 3, 2005

(54) Disposable container for immiscible products such as the ingredients of vinaigrette, provided with mixing means

(76) Inventor: Philippe Delouis, Champsac (FR)

Correspondence Address: YOUNG & THOMPSON, 745 SOUTH 23RD STREET, 2ND FLOOR, ARLINGTON, VA, 22202, US

(21) Appl. No.: 10/902,832

(22) Filed: Aug. 2, 2004

(30) Foreign Application Priority Data
Aug. 1, 2003 (FR) 03 09503

(51) Int. Cl. C12C 1/027

(52) U.S. Cl. 426/106

(57) ABSTRACT

A new type of container permits emulsifying a vinaigrette or other composition of immiscible products. This container is designed to made from disposable packaging. This packaging includes two chambers, one containing the composition, and the other remaining filled with air. This container also includes an emulsifying mechanism in the form of protuberances.

The present invention relates to a disposable container for immiscible products such as ingredients of vinaigrette, oil, vinegar, flavorings, mustard, this container being provided with mixing means adapted to obtain an emulsion.

There are known shakers which permit mixing products that are miscible, difficultly miscible or immiscible, but adapted to be emulsified.

Thus, for the production of a quality vinaigrette, it is necessary to mix the essential ingredients which can vary according to the recipe but which comprise at least oil for about half of the mixture and at least vinegar, ingredients which, by their nature, are not miscible.

Thus, when a suitable mixture is made, it is necessary to consume this mixture rapidly or else it separates into phases which renders the seasoning inhomogeneous and oily, without benefiting from the acidity given by the vinegar and of the taste to which the flavorings contribute.

It is known to produce industrial vinaigrettes with mixtures with little oil and a great deal of water. An emulsion is obtained by strong agitation creating a lasting emulsion, a stabilizer and other additives ensuring the stability of this emulsion. In this case, it is not a vinaigrette in the gastronomic sense, and the organoleptic qualities are hardly satisfactory.

However, given real life conditions, consumers desire to have natural products, tasty but easy to use so as to be able to prepare dishes rapidly, particularly salads.

Moreover, if the consumer desires to have different taste qualities as a function of the dishes to be seasoned, it is even necessary to provide several types of preparations and hence associated containers in this case, it is necessary that the preparations be ready to use or that they can be rapidly so made.

The solution consists in providing vinaigrette in a shaker but it is seen that several problems arise and particularly that of forming an emulsion.

As the object is to preserve the quality of the natural products, the stability of the preparation in the form of an emulsion is impossible without the addition of preservatives, stabilizers and other ingredients foreign to vinaigrette sauce.

The other solution is to provide the vinaigrette in a separated condition but to provide a suitable container, adapted to permit very rapid emulsifying, without at the same time having to shake this container for a long time.

Moreover, the container must be of low cost so as to be able to be used as disposable packaging. Thus, if the packaging is of glass, it is necessary to introduce mixing means, which is difficult and costly. As the consumer is likely to have several containers, one per selected product, the costly solutions are to be avoided.

The container according to the present invention will now be described in detail with the accompanying set of drawings, which drawings represent a particular embodiment, non-limiting, in which the different figures show:

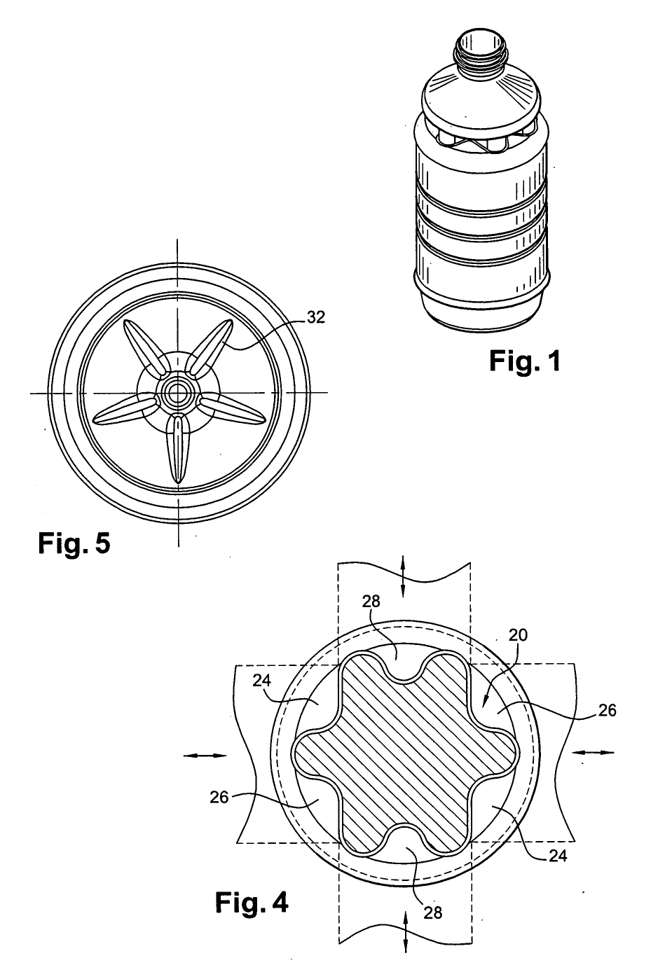

FIG. 1, a perspective view of the container according to the present invention,

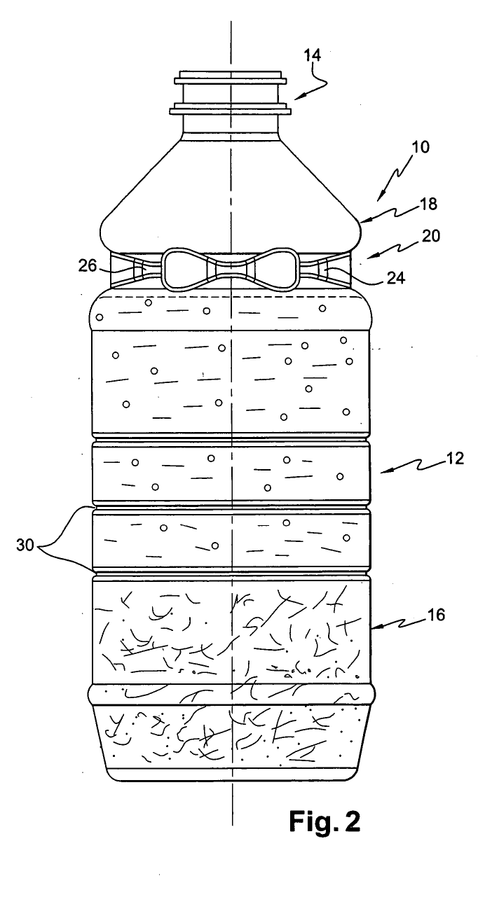

FIG. 2, a side elevational view in a first orientation,

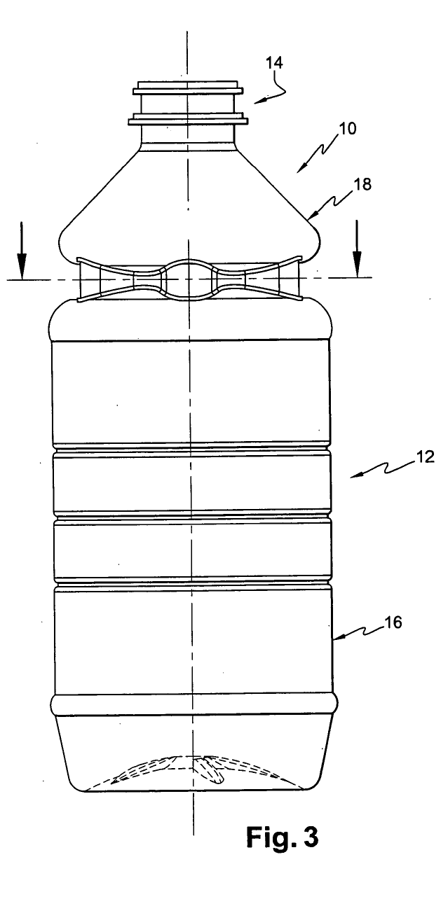

FIG. 3, a side elevational view in a second orientation, at 90° to the first,

FIG. 4, a horizontal cross-sectional view on the section line 4-4 of FIG. 3, and

FIG. 5, a view from below of the container showing the radial ribs on the bottom.

In FIG. 1, there is shown a container 10 in the form of a bottle with a body 12 and a neck 14 adapted to receive a closure, not shown.

The body of this bottle is unique in the sense that it comprises two chambers 16 and 18 between which are disposed fixed emulsifying means 20.

These features are even more visible in FIGS. 2 and 3.

As indicated in FIG. 2, the maximum liquid level is such that it fills the first chamber 16, in the lower part, and that the second chamber 18 remains filled only with air.

The first chamber thus corresponds to the useful volume of the product, 25, 50, 75 centiliters, to give examples.

The second chamber has a volume of the order of 20% of the volume of the first chamber, to give orders of magnitude.

The emulsifying means 20 project into the internal portion of the volume of the container and comprise, in the preferred embodiment shown, protuberances 22, made by molding, which ensure constriction of the passage from the first chamber to the second, see FIG. 4.

These protuberances 22 have a specific profile resulting in a compromise between emulsifying efficiency and propensity, and the ability to be produced.

Thus, so as to produce disposable packaging, resort is had to polyethylene whose shaping is obtained by blow molding. The mold must permit demolding and hence a possibility of movement of the movable parts.

As can be seen from FIG. 4, it is possible to have four pieces disposed at 90° to produce the protuberances about all the periphery.

It will be noted that the protuberances 22 are asymmetric. They are six in number, distributed according to two pairs of protuberances 24, 26 that are wide and diametrically opposed, and two narrow protuberances 28 that are diametrically opposite. In the vertical direction, there is provided a thinning of each protuberance in the central portion to constitute a sort of blade.

These variations of geometry, width, thickness, angle at the summit of the different protuberances 22, permit constituting excellent emulsifying means 20.

It is also known that in a vinaigrette, the vinegar consumes the oxygen of the air and that it is thus necessary that the container have sufficiently rigid walls so that they do not partially collapse under the effect of the slight vacuum caused by this transformation of oxygen.

The polyethylene wall should be sufficiently thick and in known manner, its rigidity is improved by the presence of ribs 30.

In FIG. 2, there is shown vinaigrette which has separated, the oil constituting the supernatant.

The user at the time of consuming this vinaigrette shakes the container and the protuberances break the flow of the passage from the first chamber 16 toward the second chamber 18, this operating being substantially instantaneous.

This second chamber is filled with air and this is an important element of the good formation of the emulsion, because the heterogeneous liquid which passes through the emulsifying means 20 is fragmented into globules, which ensures an excellent mixture and renders the composition much more homogeneous. The trapped air permits this mixture to remain stable at least for the duration of use.

During this mixing action, the bottom, shown in FIG. 5, should remain rigid and for this purpose there are provided ribs 32, in star form in the present case, in known manner.

The container also has a feature during use in that it is possible to consume all of the volume of the vinaigrette that is contained. Thus, when the container is inclined, the composition can always pass between the protuberances without the emulsifying means retaining this composition by any structure forming a barrier.

The protuberances also offer another advantage, namely, avoiding that the flow of liquid comes integrally into abutment against the closure of the bottle during shaking movements. Thus, the energy transmitted to the fluid is used and absorbed in large part by the protuberances.

This permits using closure means of the hinge and clip type so as to render the use of the container very easy.

The cost of such a container remains quite competitive and permits regarding this packaging as being disposable with possibilities of recycling, as for all the other food containers using polyethylene.

1. Disposable container (10) for a composition of immiscible products, comprising a body (12) and a neck (14) adapted to receive a closure, the body of this bottle being comprised by two chambers (16, 18) between which are disposed fixed emulsifying means (20).

2. Disposable container (10) according to claim 1, characterized in that a first of the two chambers (16) disposed in the lower part of said container contains the composition, and in that a second of the two chambers (18) remains filled with air.

3. Disposable container (10) according to claim 2, characterized in that the volume of the second chamber (18) is of the order of 20% of that of the first chamber (16).

4. Disposable container (10) according to claim 2, characterized in that the emulsifying means (20) project into the internal portion of the volume of the container and comprise protuberances (22), made by molding, which constitute a restriction of the passage from the first chamber to the second chamber.

5. Disposable container (10) according to claim 4, characterized in that the protuberances (22) are asymmetric.

6. Disposable container (10) according to claim 4, characterized in that the protuberances (22) are six in number, distributed in two pairs of wide protuberances (24, 26) diametrically opposed and two narrow protuberances (28) diametrically opposed.

7. Disposable container (10) according to claim 4, characterized in that, in the vertical direction, there is provided a thinning of each protuberance (22) in the central portion to constitute a sort of blade.

8. Disposable container (10) according to claim 4, characterized in that it is made by blow molding in a mold comprising four pieces disposed at 90° so as to form the protuberances over all the periphery and to permit demolding.

9. Disposable container (10) according to claim 1, characterized in that it is made of polyethylene and comprises grooves (30) in the wall and grooves (20) in the bottom.

10. The disposable container of claim 3, wherein the composition comprises oil and vinegar.

11. Disposable container (10) according to claim 5, characterized in that the protuberances (22) are six in number, distributed in two pairs of wide protuberances (24, 26) diametrically opposed and two narrow protuberances (28) diametrically opposed.

12. Disposable container (10) according to claim 5, characterized in that, in the vertical direction, there is provided a thinning of each protuberance (22) in the central portion to constitute a sort of blade.

13. Disposable container (10) according to claim 6, characterized in that, in the vertical direction, there is provided a thinning of each protuberance (22) in the central portion to constitute a sort of blade.

14. Disposable container (10) according to claim 2, characterized in that it is made of polyethylene and comprises grooves (30) in the wall and grooves (20) in the bottom.

15. Disposable container (10) according to claim 3, characterized in that it is made of polyethylene and comprises grooves (30) in the wall and grooves (20) in the bottom.

16. Disposable container (10) according to claim 4, characterized in that it is made of polyethylene and comprises grooves (30) in the wall and grooves (20) in the bottom.

17. Disposable container (10) according to claim 5, characterized in that it is made of polyethylene and comprises grooves (30) in the wall and grooves (20) in the bottom.

18. Disposable container (10) according to claim 6, characterized in that it is made of polyethylene and comprises grooves (30) in the wall and grooves (20) in the bottom.

19. Disposable container (10) according to claim 7, characterized in that it is made of polyethylene and comprises grooves (30) in the wall and grooves (20) in the bottom.

20. Disposable container (10) according to claim 8, characterized in that it is made of polyethylene and comprises grooves (30) in the wall and grooves (20) in the bottom.
